(19) United States
(12) Patent Application Publication
(10) Pub. No.: US 2025/0321360 A1
(43) Pub. Date: Oct. 16, 2025

(54) LENS MODULE AND TERMINAL DEVICE

(71) Applicant: AAC OPTICS (CHANGZHOU) CO., LTD., Changzhou (CN)

(72) Inventors: Huaiyu Chen, Changzhou (CN); Jia Wang, Changzhou (CN); Pingping Wang, Changzhou (CN)

(21) Appl. No.: 18/744,732

(22) Filed: Jun. 17, 2024

Related U.S. Application Data
(63) Continuation of application No. PCT/CN2024/087326, filed on Apr. 11, 2024.

(51) Int. Cl. G02B 1/11; G02B 5/20

(52) U.S. Cl. CPC G02B 1/11; G02B 5/208

(57) ABSTRACT

Provided are a lens module and a terminal device. The lens module includes a plurality of lenses. Any one of lenses has an image surface and an objective surface, and the objective surfaces and the image surfaces include at least one smooth surface. An angle between a tangent line of a point within an optically effective diameter and a tangent line of the center of the smooth surface is 0°-20°. At least one of the plurality of lenses is a specific wavelength-absorbing glass lens, and at least one smooth surface is arranged on the specific wavelength-absorbing glass lens. The lens module further includes an ultraviolet infrared cutoff film, which is arranged on the smooth surface of the specific wavelength-absorbing glass lens. The present application can at least reduce the thickness of the lens module, improve the angular drift problem, and attenuate the ghosting phenomenon.

### CROSS-REFERENCE TO RELATED APPLICATIONS

This application is a continuation of International Application No. PCT/CN2024/087326, filed Apr. 11, 2024, the entire contents of which are incorporated herein by reference.

### TECHNICAL FIELD

The present application relates to the technical field of optical lens, in particular to a lens module and a terminal device.

### BACKGROUND

Current terminal devices are usually equipped with a lens module to achieve imaging functions, and these lens modules in terminal devices are typically designed for visible light imaging. In order to avoid infrared light incident on the photosensitive elements of the lens module to form an interference light affecting the normal imaging quality, lens modules are usually equipped with filters to block infrared light.

As the demand for higher image quality from lens modules increases, the number of lenses continues to grow, leading to an increase in the overall height of the lens module. The presence of the light filter contributes to the thickness of the lens module, which can cause ghosting and affect the image quality. Additionally, the problem of angle drift in lens transmittance also needs to be improved.

### SUMMARY

An object of embodiments of the present application is to provide a lens module and a terminal device, which can satisfy the requirements of infrared cutoff, small angular drift of the lens transmittance, high imaging quality, and thinness of the lens module without having to configure a light filter to cutoff infrared light.

In order to solve the above technical problems, in an aspect, the present application provides a lens module comprising:
a plurality of lenses arranged in sequence from an objective side to an image side, wherein any one of the plurality of lenses has an image surface facing the image side and an objective surface facing the objective side; there is at least one smooth surface among the objective surfaces and the image surfaces, and an angle between a tangent line of a point within an optically effective diameter on the smooth surface used for imaging other than a center of the smooth surface and a tangent line of the center of the smooth surface is 0°-20°; at least one of the plurality of lenses is a specific wavelength-absorbing glass lens and at least one of the smooth surfaces is located on the specific wavelength-absorbing glass lens; and
an ultraviolet infrared cutoff film, wherein the ultraviolet infrared cutoff film is arranged on the smooth surface of the specific wavelength-absorbing glass lens, and the ultraviolet infrared cutoff film is absorptive of light with ultraviolet and infrared bands.

In some embodiments, the lens module further comprises an absorbing coating, wherein the absorbing coating is configured to absorb light with a specific wavelength, and the specific wavelength comprises at least one of an ultraviolet band, an infrared band, and a near-infrared band; the absorbing coating and the ultraviolet infrared cutoff film are both arranged on the smooth surface of the specific wavelength-absorbing glass lens, and the absorbing coating is located between the ultraviolet infrared cutoff film and the smooth surface.

In some embodiments, the lens module further comprises:
an absorbing coating, wherein the absorbing coating is configured to absorb light with a specific wavelength, and the specific wavelength comprises at least one of an ultraviolet band, an infrared band, and a near-infrared band; and
a plastic lens, wherein the other smooth surface is arranged on the plastic lens; the ultraviolet infrared cutoff film is arranged on the smooth surface of the specific wavelength-absorbing glass lens, and the absorbing coating is provided on the smooth surface of the plastic lens.

In some embodiments, the specific wavelength-absorbing glass lens is a blue glass lens.

In an aspect, the present application further provides a lens module, a plurality of lenses arranged in sequence from an objective side to an image side, wherein any one of the plurality of lenses has an image surface facing the image side and an objective surface facing the objective side; there is at least one smooth surface among the objective surfaces and the image surfaces, and an angle between a tangent line of a point within an optically effective diameter on the smooth surface used for imaging other than a center of the smooth surface and a tangent line of the center of the smooth surface is 0°-20°; the plurality of lenses comprise at least one specific wavelength-absorbing glass lens and at least one second glass lens; and
an ultraviolet infrared cutoff film, wherein the ultraviolet infrared cutoff film is provided on the smooth surface of the specific wavelength-absorbing glass lens or on the smooth surface of the second glass lens, and the ultraviolet infrared cutoff film is absorptive of light in the ultraviolet and infrared bands.

In some embodiments, the lens module further comprises an absorbing coating, wherein the absorbing coating is configured to absorb light with a specific wavelength, and the specific wavelength comprises at least one of an ultraviolet band, an infrared band, and a near-infrared band; the absorbing coating and the ultraviolet infrared cutoff film are both arranged on the same smooth surface, and the absorbing coating is located between the ultraviolet infrared cutoff film and the smooth surface.

In some embodiments, the lens module further comprises an absorbing coating, wherein the absorbing coating is configured to absorb light with a specific wavelength, and the specific wavelength comprises at least one of an ultraviolet band, an infrared band, and a near-infrared band; one of the ultraviolet infrared cutoff film and the absorbing coating is arranged in the smooth surface of the specific wavelength-absorbing glass lens, and the other one of the ultraviolet infrared cutoff film and the absorbing coating absorbing coating is arranged in the second glass lens of the smooth surface.

In some embodiments, the lens module further comprises:
absorbing coatings, wherein each of the absorbing coatings is configured to absorb light with a specific wavelength, and the specific wavelength comprises at least one of an ultraviolet band, an infrared band, and a near-infrared band; and
a plastic lens, wherein one of the absorbing coatings is arranged on a smooth surface of the plastic lens.

In some embodiments, the specific wavelength-absorbing glass lens is a blue glass lens.

In another aspect, the present application provides a terminal device comprising a lens module as described in the above-mentioned embodiments.

The beneficial effect of the present application is that the lens module includes an ultraviolet infrared cutoff film, which can absorb light in the ultraviolet and infrared bands, and can replace a light filter in the related art. Without using the light filter in the related art, the thickness of the lens module can be reduced so that the lens module can be thin and light. A plurality of lenses of the lens module may comprise at least one specific wavelength-absorbing glass lens, and the ultraviolet infrared cutoff film is arranged on a smooth surface of the specific wavelength-absorbing glass lens. The smooth surface is smooth, so that the spectral drift at the center and edge positions of the lens can be smaller. Besides, the specific wavelength-absorbing glass lens enables smaller angular shifts of the incident angle in lens module transmittance, thus improving the angular shift in transmittance in related art. The lens module of the embodiment of the present application also has a high infrared cutoff absorption value and high imaging quality. The plurality of lenses in the lens module may also include at least one specific wavelength-absorbing glass lens and at least one second glass lens. The ultraviolet infrared cutoff film may be provided on a smooth surface of the specific wavelength-absorbing glass lens or on a smooth surface of the second glass lens. The smooth surface is smooth, so that the spectral drift of the center and edge positions of the lens can be smaller, and the angular offset of the lens module can be smaller, thereby improving the angular offset problem in the related technology. The lens module of the embodiment of the present application also has a higher infrared cutoff absorption value and a higher imaging quality.

### BRIEF DESCRIPTION OF THE DRAWINGS

One or more embodiments are illustrated exemplarily by means of figures in the accompanying drawings corresponding thereto, these exemplary illustrations do not constitute a limitation of the embodiments, and the figures in the accompanying drawings do not constitute a limitation of proportions unless specifically affirmed. In order to illustrate the embodiments of the present application or the technical solutions in the conventional technology more clearly, the accompanying drawings required to be used in the embodiments will be briefly introduced in the following. Obviously, the following description of the accompanying drawings are only some of the embodiments of the present application, and other accompanying drawings may be obtained from these drawings by a person of ordinary skill in the art without creative labor.

FIG. 1 shows a structural schematic diagram of a lens module in the related art.

FIG. 2 shows a structural schematic diagram of a lens module provided in Embodiment One of the present application.

FIG. 3 shows a structural schematic diagram of a first lens in the lens module provided in Embodiment One of the present application.

FIG. 4 shows a schematic diagram of a partial structure of FIG. 3.

FIG. 5 shows a structural schematic diagram of a lens module provided in Embodiment Two of the present application.

FIG. 6 is a structural schematic diagram of a lens module provided in Embodiment Three of the present application.

FIG. 7 shows a structural schematic diagram of a lens module provided in Embodiment Four of the present application.

FIG. 8 shows a structural schematic diagram of a lens module provided in Embodiment Five of the present application.

FIG. 9 shows a structural schematic diagram of a lens module provided in Embodiment Five of the present application.

FIG. 10 shows a structural schematic diagram of a lens module provided in Embodiment Seven of the present application.

FIG. 11 shows a structural schematic diagram of the lens module provided in Comparative Embodiment Two.

FIG. 12 shows a transmittance curve graph of light incident at 0° and 30° for the lens module in Comparative Embodiment One.

FIG. 13 shows a transmittance curve graph of light incident at 0° and 30° for the lens module in Comparative Embodiment Two.

FIG. 14 shows a transmittance curve graph of light incident at 0° and 30° for the lens module in Embodiment One.

FIG. 15 shows a transmittance curve graph of light incident at 0° and 30° for the lens module in Embodiment Two.

FIG. 16 shows a transmittance curve graph of light irradiated on the inside of the blue glass lens in Comparative Embodiment One, Embodiment One, and Embodiment Two.

FIG. 17 shows a transmittance curve graph of light irradiated on the inside of the stained plastic lenses in Comparative Embodiment Two.

FIG. 18 shows a transmittance curve graph of light irradiated on the blue glass lens in Embodiment Two.

FIG. 19 shows a schematic diagram of a kind of ghosting simulation of the lens module in Comparative Embodiment One.

FIG. 20 shows an enlarged schematic diagram of the A1 region in FIG. 19.

FIG. 21 shows an enlarged schematic diagram of the B1 region in FIG. 19.

FIG. 22 shows a schematic diagram of a kind of ghosting simulation of the lens module in Comparative Embodiment Two.

FIG. 23 shows a schematic diagram of a kind of ghosting simulation of the lens module in Embodiment One.

FIG. 24 shows a schematic diagram of a kind of ghosting simulation of the lens module in Embodiment Two.

FIG. 25 shows a schematic diagram of a kind of ghosting simulation of the lens module in Comparative Embodiment One.

FIG. 26 shows an enlarged schematic diagram of the A2 region in FIG. 25.

FIG. 27 shows an enlarged schematic diagram of the B2 region in FIG. 25.

FIG. 28 shows a schematic diagram of a kind of ghosting simulation of the lens module in Comparative Embodiment Two.

FIG. 29 shows a schematic diagram of a kind of ghosting simulation of the lens module in Embodiment One.

FIG. 30 shows a schematic diagram of a kind of ghosting simulation of the lens module in Embodiment Two.

FIG. 31 shows a schematic diagram of a kind of ghosting simulation of the lens module in Comparative Embodiment One.

FIG. 32 shows a schematic diagram of a kind of ghosting simulation of the lens module in Comparative Embodiment Two.

FIG. 33 shows an enlarged schematic of the A3 region in FIG. 32.

FIG. 34 shows an enlarged schematic diagram of the B3 region in FIG. 32.

FIG. 35 is a schematic diagram of a kind of ghosting simulation of the lens module in Embodiment One.

FIG. 36 shows a schematic diagram of a ghosting simulation of the lens module in Embodiment Two.

FIG. 37 shows a schematic diagram of a kind of ghosting simulation of the lens module in Comparative Embodiment One.

FIG. 38 shows an enlarged schematic of the A4 region in FIG. 37.

FIG. 39 shows a schematic diagram of a kind of ghosting simulation of the lens module in Comparative Embodiment Two.

FIG. 40 shows a schematic diagram of a kind of ghosting simulation of the lens module in Embodiment One.

FIG. 41 shows a schematic diagram of a kind of ghosting simulation of the lens module in Embodiment Two.

### DETAILED DESCRIPTION OF THE EMBODIMENTS

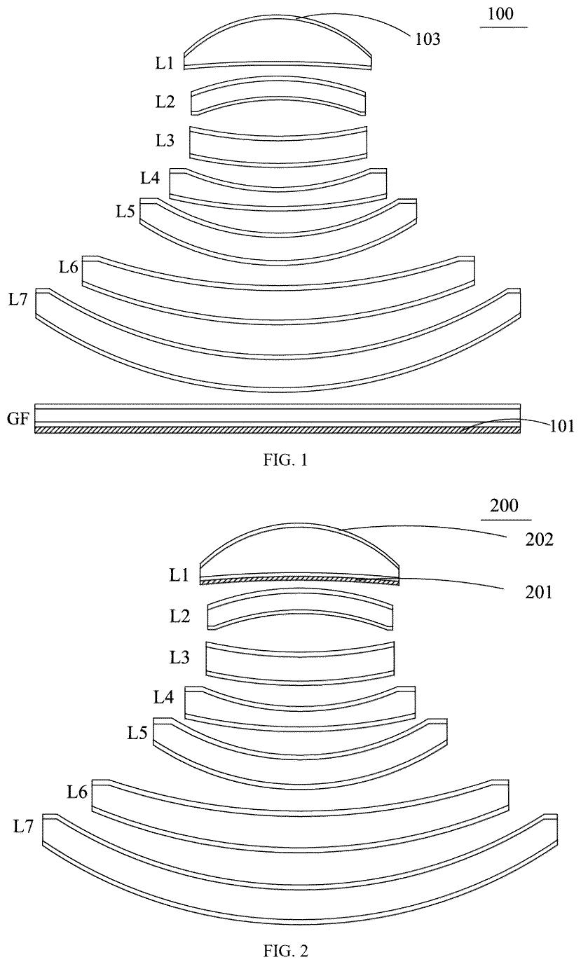

FIG. 1 shows a structural schematic diagram of a lens module in the related art.

As shown in FIG. 1, the lens module 100 in the related art includes a plurality of lenses arranged sequentially from an objective side to the image side. In FIG. 1, for example, seven lenses are shown, including a first lens L1, a second lens L2, a third lens L3, a fourth lens L4, a fifth lens L5, a sixth lens L6, and a seventh lens L7. The lens module 100 further includes a light filter GF (Glass Filter).

The light filter GF is configured to absorb light in the infrared band to improve the optical quality of the lens module. However, the light filter GF occupies a certain amount of space, making the thickness of the lens module 100 larger, and is prone to ghosting phenomena affecting the imaging quality of the lens module 100, and the angular drift of the lens module also needs to be improved.

Embodiments of the present application provide a lens module including a plurality of lenses arranged sequentially from an objective side to an image side. Any one of the lenses in the plurality of lenses has an image surface facing the image side and an objective surface facing the objective side, and the objective surfaces and the image surfaces include at least one smooth surface. An angle between a tangent line of a point on the smooth surface used for imaging other than the center of the smooth surface and a tangent line of the center of the smooth surface is 0°-20°. At least one of the plurality of lenses is a specific wavelength-absorbing glass lens. and at least one of the smooth surfaces is located on the specific wavelength-absorbing glass lens. The lens module further includes an ultraviolet infrared cutoff film, which is arranged on the smooth surface of the specific wavelength-absorbing glass lens. The ultraviolet infrared cutoff film is provided on the smooth surface of the specific wavelength-absorbing glass lens, which can replace the light filter in the related art, so that the thickness of the lens module of the embodiment of the present application can be smaller. The ultraviolet infrared cutoff film is arranged on the smooth surface of the specific wavelength-absorbing glass lens, and an angle between a tangent line of a point within an optically effective diameter on the smooth surface used for imaging other than a center of the smooth surface and a tangent line of the center of the smooth surface is 0°-20°. The value of the angle is small, so the spectral drift at the center and edge positions of the lens is small, thus the lens module of the embodiments of the present application can improve the problem of angular drift. Besides, the lens module of the embodiments of the present application has a high infrared cutoff absorption value, which also attenuates the ghosting phenomenon and improves the imaging quality of the lens module. Embodiments of the present application further provide a lens module including a plurality of lenses arranged in sequence from an objective side to an image side. Any one of the lenses in the plurality of lenses has an image surface facing the image side and an objective surface facing the objective side, and the objective surfaces and the image surfaces include at least one smooth surface. An angle between a tangent line of a point within an optically effective diameter on the smooth surface used for imaging other than a center of the smooth surface and a tangent line of the center of the smooth surface is 0°-20°, where the optically effective diameter for imaging means a lens area through which light can pass and reach the optical imaging sensor to participate in imaging after passing through the lens, and correspondingly, a structural area for supporting a fixed lens, which is provided outside of the optically effective diameter. The plurality of lenses includes at least one specific wavelength-absorbing glass lens and at least one second glass lens. The lens module includes an ultraviolet infrared cutoff film, which is provided on a smooth surface of the specific wavelength-absorbing glass lens or on a smooth surface of the second glass lens. The presence of the ultraviolet infrared cutoff film can replace the light filter of the lens module in the related art, so as to reduce the thickness of the lens module in the embodiment of the present application. The ultraviolet infrared cutoff film can be provided on the smooth surface of the specific wavelength-absorbing glass lens or on the smooth surface of the second glass lens. The smooth surface is smoother, so that the spectral drift at the center and edge positions of the lens is small, which can improve the angular drift problem of the lens module. Besides, the lens module of the embodiment of the present application has a high infrared cutoff absorption value, which can also attenuate the ghosting phenomenon and improve the imaging quality of the lens module.

In order to make the objects, technical solutions, and advantages of the present application clearer, each embodiment of the present application will be described in detail below in conjunction with the accompanying drawings. However, a person of ordinary skill in the art can understand that in the various embodiments of the present application, a number of technical details are proposed to enable the reader to better understand the present application. Even without these technical details and various variations and modifications based on the following various embodiments, the technical solution claimed to be protected by the present application can be realized.

FIG. 2 shows a structural schematic diagram of a lens module provided in Embodiment One of the present application.

As shown in FIG. 2, Embodiment One of the present application provides a lens module 200 including a plurality of lenses arranged sequentially from an objective side to an image side. Any one of the lenses of the plurality of lenses has an image surface facing the image surface and an objective surface facing the objective side, and the objective surfaces and the image surfaces include at least one smooth surface. An angle between a tangent line of a point within an optically effective diameter on the smooth surface used for imaging other than the center of the smooth surface and a tangent line of the center of the smooth surface is 0°-20°. At least one of the plurality of lenses is a specific wavelength-absorbing glass lens and at least one of the smooth surfaces is located on the specific wavelength-absorbing glass lens. The lens module 200 further includes an ultraviolet infrared cutoff film 201, which is arranged on a smooth surface of a specific wavelength-absorbing glass lens. The light with ultraviolet and infrared bands has an absorbing effect on light with ultraviolet and infrared bands, in which the cutoff bands range from 350-420 nm and 690-1200 nm. This embodiment is an example of a seven-piece lens including a first lens L1, a second lens L2, a third lens L3, a fourth lens L4, a fifth lens L5, a sixth lens L6, and a seventh lens L7.

In this embodiment, the first lens L1 is a specific wavelength-absorbing glass lens, the second lens L2 is a plastic lens, the third lens L3 is a plastic lens, the fourth lens L4 is a plastic lens, the fifth lens L5 is a plastic lens, the sixth lens L6 is a plastic lens, and the seventh lens L7 is a plastic lens.

It is to be understood that the embodiment of the present application takes seven lenses as an example, and in other embodiments, the number of lenses of the lens module may be other numbers, such as three lenses, four lenses, five lenses, six lenses, or eight lenses. The embodiment of the present application is exemplified by the lens module including one specific wavelength-absorbing glass lens, and the ultraviolet infrared cutoff film is located on a smooth surface of the glass lens. In other embodiments, the number of specific wavelength-absorbing glass lenses of the lens module may be more than one, such as two, or three. The ultraviolet infrared cutoff film may be located on a smooth surface of any one of the specific wavelengths absorbing glass lenses when the number of glass lenses in the lens module is more than one. The present embodiment of the present application uses the first lens L1 as the specific wavelength-absorbing glass lens example. In other embodiments, other lenses, such as the second lens L2, the third lens L3, or the fourth lens L4, etc., may also be specific wavelength-absorbing glass lenses. In this embodiment, the first lens L1 having a smooth surface on the image surface is taken as an example, and in fact, the objective surface of the first lens L1 may also be a smooth surface.

The specific wavelength-absorbing glass lens has an absorption effect of 550 nm-1100 nm and is capable of absorbing light in the infrared band, thereby improving the infrared cutoff absorption value of the lens module 200. The specific wavelength-absorbing glass lens may be a blue glass lens or a stained glass that has an absorption effect on light with the infrared band.

In this embodiment, the first lens L1 may be a blue glass lens. The blue glass lens is made of blue glass material as the raw material, and its effect is to filter the infrared light by absorption. Due to the light with blue wavelengths having a high transmittance rate, the blue glass lens has a better transmittance than other glass lenses. In other embodiments, the first lens L1 may also be a green glass lens, and the green glass lens absorbs light with the infrared band.

In this embodiment, the plurality of lenses of the lens module 200 may all be aspherical lenses, and the aspherical lenses can provide a more natural, less visually distorted visual effect, which makes the visual object look more realistic and can improve the optical performance of the lens module 200. The aspherical lenses also have a high degree of durability and abrasion resistance, which can improve the reliability of the lens module 200.

In other embodiments, the lens in the lens module may also be a spherical lens.

The first lens L1 may be produced using wafer level glass technology (WLG), molded glass technology (GMO), or wafer level optical element technology (WLO). The WLG wafer level glass technology involves molding a glass wafer by softening, heating, and molding them in high-precision molds, and then cutting, cleaning, and coating them with film. The GMO molded glass technology involves heating, molding, cooling, material extraction, film deposition, and other processes to manufacture glass blanks. The WLO wafer level optical component technology entails coating optical adhesive on glass substrates, curing them into shape, and finally cutting them. Among these, the WLG technology offers advantages in terms of feasibility for large-scale production, production efficiency, lens precision, and performance, thereby enhancing the quality and production efficiency of the lens module 200.

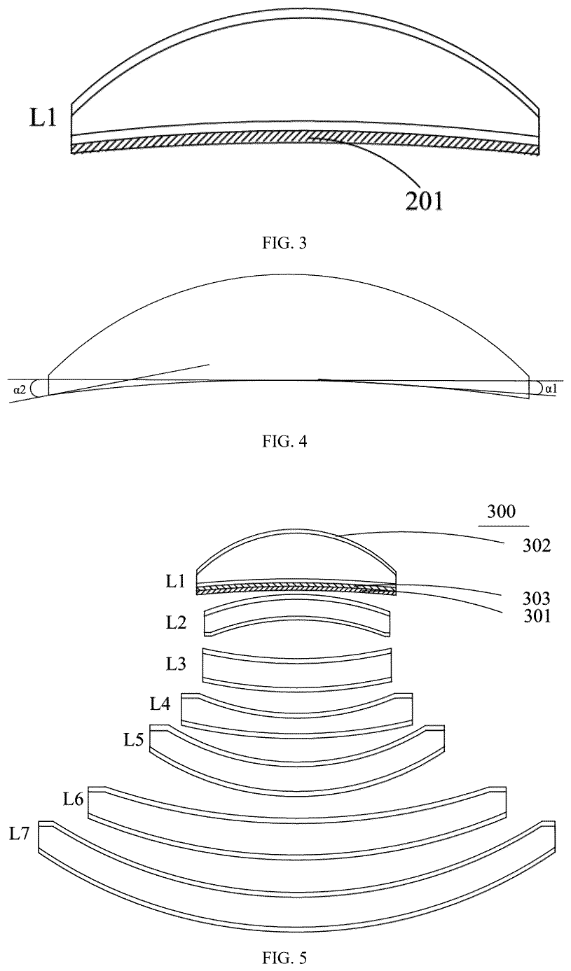

FIG. 3 shows a structural schematic diagram of a first lens in the lens module provided in Embodiment One of the present application. FIG. 4 shows a schematic diagram of one partial structure of FIG. 3.

As shown in FIGS. 3 and 4, an angle between a tangent line of a point within an optically effective diameter on the smooth surface used for imaging other than a center of the smooth surface and a tangent line of the center of the smooth surface is 0°-20°, such as, 0°, 3°, 6°, 9°, 12°, 15°, 18°, or 20°. FIG. 4 shows that the angles α1 and α2 are less than 20°, and in fact, the angles between a tangent line of a different point other than the center of the smooth surface and a tangent line of the center of the smooth surface are different, the values of which are within 0°-20°. Within this range, it can lead to a smaller spectral angular drift between the center of the first lens and the edge position, and thus the lens module 200 can improve the angular drift problem.

It should be understood that FIG. 4 illustrates a smooth surface of the first lens of the present embodiment, and reference may likewise be made to FIG. 4 with respect to smooth surfaces on other lenses.

The ultraviolet infrared cutoff film 201 is an Infra-Red Cut (IRCUT) film, which is configured to act as a cutoff for light in the infrared band, and the ultraviolet infrared cutoff film 201 has a high infrared cutoff absorption value, so as to make the lens module 200 have a high infrared cutoff absorption value.

It should be noted that if the ultraviolet infrared cutoff film is deposited on the surface of a plastic lens such as a resin lens, there will be problems such as low performance of the film layer, large variations in the face type, poor stability, poor reliability, etc. If the ultraviolet infrared cutoff film is deposited on the surface of a white glass lens, the color of the film will be red affecting the color of the lens appearance. If the ultraviolet infrared cutoff film is deposited on a specific wavelength-absorbing glass lens, the film color will not appear red, and it also has the advantages of high performance of the film layer, small changes in the face type, good stability, good reliability, and so on. Therefore, the embodiment of the present application chooses to deposit the ultraviolet infrared cutoff film on the specific wavelength-absorbing glass lens, which can improve the imaging quality of the lens module.

In an embodiment, the ultraviolet infrared cutoff film 201 may be deposited on the smooth surface of the first lens L1 by an atomic layer deposition process, so that the ultraviolet infrared cutoff film 201 has a high uniformity and denseness on the smooth surface of the first lens L1, which can improve the reliability of the cutoff film 201 in filtering infrared light.

In an embodiment, the ultraviolet infrared cutoff film 201 may also be deposited on the smooth surface of the first lens L1 by a physical vapor deposition process (PVD), and the PVD may achieve a higher film deposition rate, so that the ultraviolet infrared cutoff film 201 is deposited on the first lens L1 at a faster rate, which can improve the production efficiency of the lens module 200. The PVD can also be carried out at a low temperature, which reduces the thermal stress and oxidation risk of the substrate material, so that the ultraviolet infrared cutoff film 201 can have a high degree of crystallinity, denseness, and flatness, thereby improving the reliability of the lens module 200. The PVD does not require the use of a chemical reaction or a high-temperature heat source, which can reduce energy consumption, as compared to other deposition techniques.

In an embodiment, the lens module 200 further includes an anti-reflection film 202, which is arranged on the objective surface and image surface of the lens. The anti-reflection film 202, is also known as AR film or transmittance-enhancing film. The anti-reflection film 202 is configured to reduce or eliminate the reflected light from optical surfaces such as prisms, plane lenses, and the like, so as to increase the amount of light transmitted by the lens and enable the light to be maximized to be presented to the user, thereby improving the optical performance of the lens module 200.

FIG. 5 shows a structural schematic diagram of a lens module provided in Embodiment Two of the present application.

As shown in FIG. 5, Embodiment Two of the present application provides a lens module 300. Embodiment Two is basically the same as Embodiment One, and the meaning of the symbols is the same as that of Embodiment One. The ultraviolet infrared cutoff film 301 and the anti-reflection film 302 may be described with reference to the corresponding description of Embodiment One and will not be repeated herein.

In this embodiment, the first lens L1 is a specific wavelength-absorbing glass lens, the second lens L2 is a plastic lens, the third lens L3 is a plastic lens, the fourth lens L4 is a plastic lens, the fifth lens L5 is a plastic lens, the sixth lens L6 is a plastic lens, and the seventh lens L7 is a plastic lens.

The lens module 300 further includes an absorbing coating 303, which absorbs light with a specific wavelength, and the specific wavelength includes at least one of an ultraviolet band, an infrared band, and a near-infrared band. The absorbing coating 303 has an absorbing effect on light in the infrared band, which can increase the infrared cutoff absorption value of the lens module 300, while further reducing the difference in transmittance between different angles of incidence.

In this embodiment, the absorbing coating 303 and the ultraviolet infrared cutoff film 301 are both provided on the smooth surface of the first lens L1, and the absorbing coating 303 is arranged between the ultraviolet infrared cutoff film 301 and the smooth surface of the first lens L1. The absorbing coating 303 may be prepared on the smooth surface of the first lens L1 using a spin-coating process, the spin-coating process is simple to operate and inexpensive, which is conducive to improving the preparation efficiency of the absorbing coating 303 and reducing the cost of production. The smooth surface is smoother, which improves the reliability of the absorbing coating 303 being spin-coated on the first lens L1.

In this embodiment, the absorbing coating 303 is located between the smooth surface of the first lens L1 and the ultraviolet infrared cutoff film 301. When preparing the absorption coating 303 and the ultraviolet infrared cutoff film 301 on the first lens L1, compared to the scheme of first depositing the ultraviolet infrared cutoff film 301 on the first lens L1 and then spin-coating the absorption coating 303 on the surface of the ultraviolet infrared cutoff film 301, spin-coating the absorption coating 303 on the first lens L1 first and then depositing the ultraviolet infrared cutoff film 301 on the absorption coating 303 does not cause the problem of insufficient adhesion of the absorption coating 303 caused by spin-coating the absorption coating 303 on the ultraviolet infrared cutoff film 301 does not occur, and thus the reliability of the lens module 300 can be improved by locating the absorption coating 303 between the smooth interface of the first lens L1 and the ultraviolet infrared cutoff film 301.

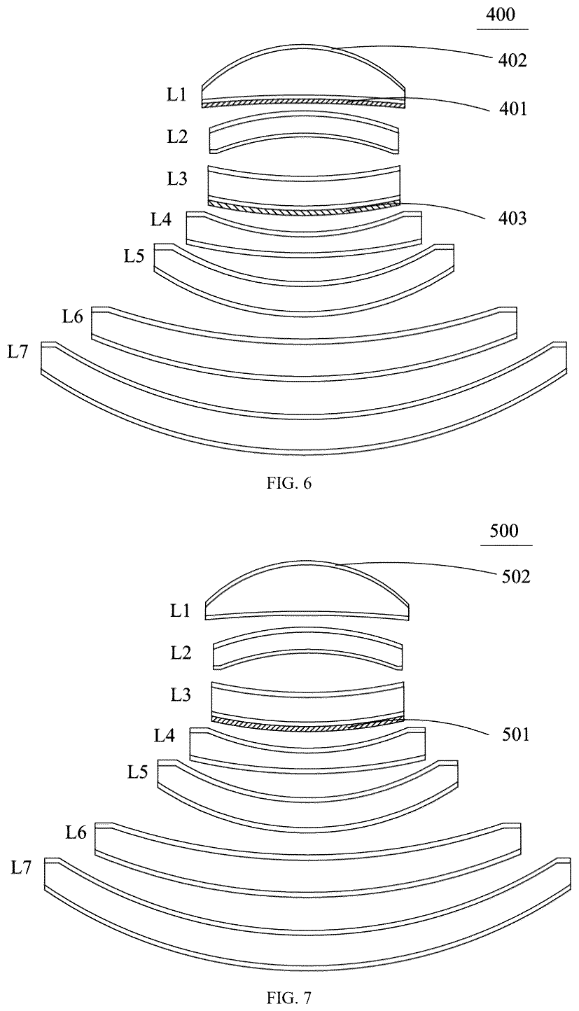

FIG. 6 shows a structural schematic diagram of a lens module provided in Embodiment Three of the present application.

As shown in FIG. 6, Embodiment Three of the present application provides a lens module 400. The third embodiment is basically the same as Embodiment One, and the meaning of the symbols is the same as that of Embodiment One. The ultraviolet infrared cutoff film 401 and the anti-reflection film 402 may be described with reference to the corresponding description of Embodiment One and will not be repeated herein.

In this embodiment, the first lens L1 is a specific wavelength-absorbing glass lens, the second lens L2 is a plastic lens, the third lens L3 is a plastic lens, the fourth lens L4 is a plastic lens, the fifth lens L5 is a plastic lens, the sixth lens L6 is a plastic lens, and the seventh lens L7 is a plastic lens.

The lens module 400 further includes an absorbing coating 403, which absorbs light with a specific wavelength, and the specific wavelength includes at least one of an ultraviolet band, an infrared band, and a near-infrared band. The absorbing coating 403 has an absorbing effect on the light in the infrared band, which can further increase the infrared cutoff absorption value of the lens module 400.

The absorbing coating 403 is arranged on a smooth surface of the third lens L3. The absorbing coating 403 may be prepared on the smooth surface of the third lens L3 using a spin-coating process. The spin-coating process is simple to operate and inexpensive, which is conducive to improving the preparation efficiency of the absorbing coating 403 and reducing the cost of production. The smooth surface is smoother, which may improve the reliability of the absorbing coating 403 spin-coated on the third lens L3.

It is to be understood that this embodiment takes the absorbing coating on the third lens L3 as an example, and in other embodiments, the absorbing coating may also be arranged on the smooth surface of other plastic lenses.

FIG. 7 shows a structural schematic diagram of a lens module provided in Embodiment Four of the present application.

With reference to FIG. 7, Embodiment Four of the present application provides a lens module 500 including a plurality of lenses arranged in a sequential row from an objective side to an image side. Any one of the plurality of lenses has an image surface facing the image surface and an objective surface facing the objective side. The objective surfaces and the image surfaces include at least one smooth surface. An angle between a tangent line of a point within an optically effective diameter on the smooth surface used for imaging other than the center of the smooth surface and a tangent line of the center of the smooth surface is 0°-20°. The plurality of lenses includes at least one specific wavelength-absorbing glass lens and at least one second glass lens. The lens module 200 further includes an ultraviolet infrared cutoff film 201, which is provided on the smooth surface of the second glass lens, and has an absorbing effect on light in the infrared band. The present embodiment is illustrated with seven lenses, which include a first lens L1, a second lens L2, a third lens L3, a fourth lens L4, a fifth lens L5, a sixth lens L6, and a seventh lens L7.

In this embodiment, the first lens L1 is a specific wavelength-absorbing glass lens, the second lens L2 is a plastic lens, the third lens L3 is a second glass lens, the fourth lens L4 is a plastic lens, the fifth lens L5 is a plastic lens, the sixth lens L6 is a plastic lens, and the seventh lens L7 is a plastic lens.

It is to be understood that the embodiment of the present application takes seven lenses as an example, and in other embodiments, the number of lenses of the lens module may be other numbers, such as three, four, five, six, or eight lenses. The embodiment of the present application is exemplified by the lens module including a specific wavelength-absorbing glass lens and a second glass lens, and the ultraviolet infrared cutoff film may be arranged on a smooth surface of the second glass lens. In other embodiments, the ultraviolet infrared cutoff film may also be arranged on a smooth surface of the specific wavelength-absorbing glass lens. In the lens module of the embodiment of the present application, the first lens L1 is a specific wavelength-absorbing glass lens as an example, and in other embodiments, other lenses, such as the second lens L2, the third lens L3, or the fourth lens L4, may also be specific wavelength-absorbing glass lenses. The third lens L3 is a second glass lens in the lens module of the embodiment of the present application as an example, and in other embodiments, it may also be other lenses, such as the first lens L1, the second lens L2, or the fourth lens L4, as a second glass lens.

The second glass lens is a lens made of glass and may be a white glass lens or the like.

The specific wavelength-absorbing glass lens, the ultraviolet infrared cutoff film 501, and the reflection reduction film 502 in this embodiment may be referred to the corresponding description of Embodiment One and will not be repeated here.

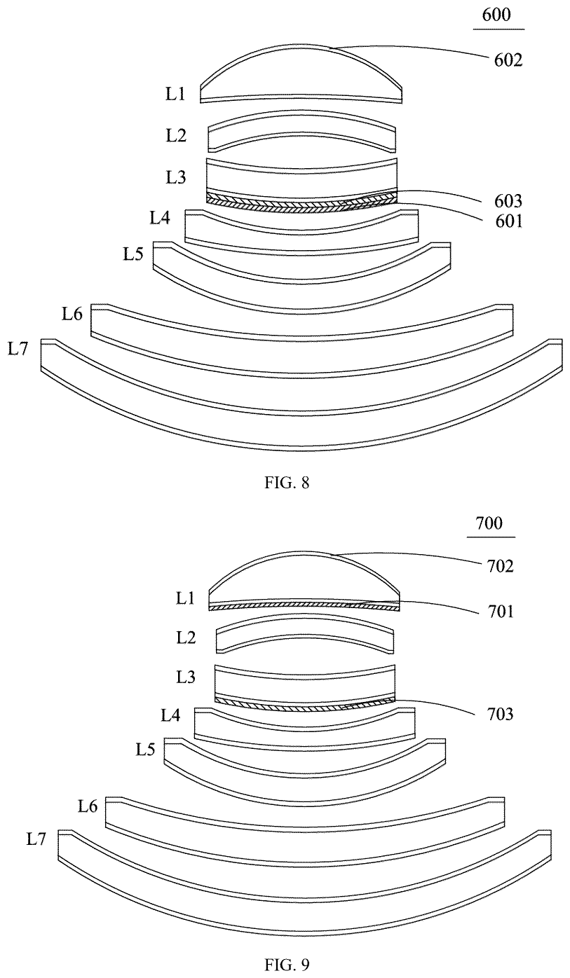

FIG. 8 shows a structural schematic diagram of a lens module provided in Embodiment Five of the present application.

As shown in FIG. 8, Embodiment Five of the present application provides a lens module 600. Embodiment Five is basically the same as Embodiment Four, and the meaning of the symbols is the same as that of Embodiment One. The ultraviolet infrared cutoff film 601 and the anti-reflection film 602 may be described with reference to the corresponding description of Embodiment Four and will not be repeated herein.

In this embodiment, the first lens L1 is a specific wavelength-absorbing glass lens, the second lens L2 is a plastic lens, the third lens L3 is a second glass lens, the fourth lens L4 is a plastic lens, the fifth lens L5 is a plastic lens, the sixth lens L6 is a plastic lens, and the seventh lens L7 is a plastic lens.

The lens module 600 further includes an absorbing coating 603, which is configured to absorb light with a specific wavelength, and the specific wavelength includes at least one of an ultraviolet band, an infrared band, and a near-infrared band. The absorbing coating 603 absorbs light in the infrared band, which can increase the infrared cutoff absorption value of the lens module 600.

In this embodiment, the absorbing coating 603 and the ultraviolet infrared cutoff film 601 are both arranged on a smooth surface of the third lens L3, and the absorbing coating 603 is located between the ultraviolet infrared cutoff film 301 and the smooth surface of the third lens L3. Compared to the scheme of first depositing the ultraviolet infrared cut-off film 601 on the third lens L3 and then spin-coating the absorption coating 603 on the surface of the ultraviolet infrared cutoff film 601, first spin-coating the absorption coating 603 on the third lens L3 and then depositing the ultraviolet infrared cut-off film 601 on the absorption coating 603 will not cause the problem of insufficient adhesion of the absorption coating 603 caused by spin-coating the absorption coating 603 on the ultraviolet infrared cut-off film 301, thereby improving the reliability of the lens module 600 by arranging the absorbing coating 603 between the smooth interface of the third lens L3 and the ultraviolet infrared cutoff film 601.

FIG. 9 shows a structural schematic diagram of a lens module provided in Embodiment Six of the present application.

As shown in FIG. 9, Embodiment Six of the present application provides a lens module 700. Embodiment Six is basically the same as Embodiment Four, and the meaning of the symbols is the same as that of Embodiment Four. The ultraviolet infrared cutoff film 701 and the anti-reflection film 702 may be described with reference to the corresponding description of Embodiment Four and will not be repeated herein.

In this embodiment, the first lens L1 is a specific wavelength-absorbing glass lens, the second lens L2 is a plastic lens, the third lens L3 is a second glass lens, the fourth lens L4 is a plastic lens, the fifth lens L5 is a plastic lens, the sixth lens L6 is a plastic lens, and the seventh lens L7 is a plastic lens.

The lens module 700 further includes an absorbing coating 703, which is configured to absorb light with a specific wavelength, and the specific wavelength includes at least one of an ultraviolet band, an infrared band, and a near-infrared band. The absorbing coating 703 absorbs light in the infrared band, which can increase the infrared cutoff absorption value of the lens module 700.

It is to be understood that in this embodiment, the ultraviolet infrared cutoff film 701 is provided on a smooth surface of the specific wavelength-absorbing glass lens, and the absorbing coating 703 is provided on a smooth surface of the second glass lens. In other embodiments, the ultraviolet infrared cutoff film 701 may be provided on the smooth surface of the second glass lens, and the absorbing coating 703 may be provided on the smooth surface of the second glass lens.

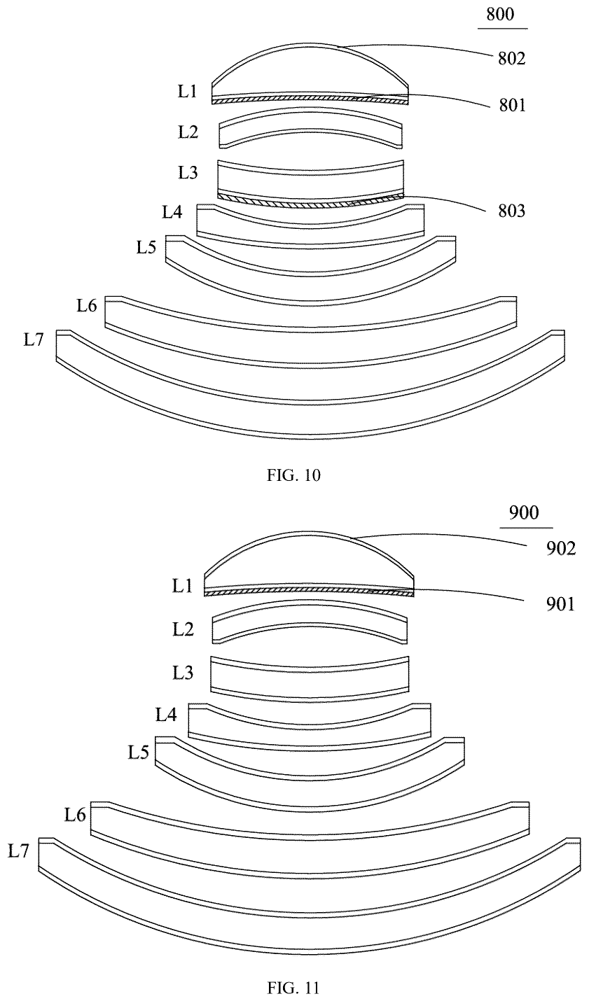

FIG. 10 shows a structural schematic diagram of a lens module provided in Embodiment Seven of the present application.

As shown in FIG. 10, Embodiment Seven of the present application provides a lens module 800. Embodiment Seven is basically the same as Embodiment Four, and the meaning of the symbols is the same as that of Embodiment Four. The ultraviolet infrared cutoff film 8701 and the anti-reflection film 802 may be described with reference to the corresponding description of Embodiment Four and will not be repeated herein.

In this embodiment, the first lens L1 is a specific wavelength-absorbing glass lens, the second lens L2 is a second glass lens, the third lens L3 is a plastic lens, the fourth lens L4 is a plastic lens, the fifth lens L5 is a plastic lens, the sixth lens L6 is a plastic lens, and the seventh lens L7 is a plastic lens.

The lens module 800 further includes an absorbing coating 803, which is configured to absorb light with a specific wavelength, and the specific wavelength includes at least one of an ultraviolet band, an infrared band, and a near-infrared band. The absorbing coating 803 absorbs light in the infrared band, which can increase the infrared cutoff absorption value of the lens module 800.

In this embodiment, the absorbing coating 803 is provided on a smooth surface of the plastic lens.

FIG. 11 shows a structural schematic diagram of a lens module provided in Comparative Embodiment Two.

As shown in FIG. 11, in the lens module 900 of Comparative Embodiment Two, the symbols of Comparative Embodiment Two have the same meaning as the symbols of Embodiment One. The ultraviolet infrared cutoff film 901 and the anti-reflection film 902 may be described with reference to the corresponding description of Embodiment Four and will not be repeated herein.

Table 1 exemplifies the lenses in the lens module of Comparative Embodiment One, Comparative Embodiment Two, Embodiment One, and Embodiment Two.

TABLE 1

| Sample | | | L1 | L2 | L3 | L4 | L5 | L6 | L7 | GF |
|---|---|---|---|---|---|---|---|---|---|---|
| Comparative | Material | | Glass | Plastic | Plastic | Plastic | Plastic | Plastic | Plastic | Blue |
| Embodiment | | | | | | | | | | Glass |
| One | Surface | R1 | AR | AR | AR | AR | AR | AR | AR | AR |
| | | | film | film | film | film | film | film | film | film + |
| | | R2 | AR | AR | AR | AR | AR | AR | AR | cutoff |
| | | | film | film | film | film | film | film | film | film |
| Comparative | Material | | White | Plastic | Stained | Plastic | Plastic | Plastic | Plastic | None |
| Embodiment | | | Glass | | Plastic | | | | | |
| Two | Surface | R1 | AR | AR | AR | AR | AR | AR | AR | |
| | | | film | film | film | film | film | film | film | |
| | | R2 | AR | AR | AR | AR | AR | AR | AR | |
| | | | film + | film | film | film | film | film | film | |
| | | | cutoff | | | | | | | |
| | | | film | | | | | | | |
| Embodiment | Material | | Blue | Plastic | Plastic | Plastic | Plastic | Plastic | Plastic | None |
| One | | | Glass | | | | | | | |
| | Surface | R1 | AR | AR | AR | AR | AR | AR | AR | |
| | | | film | film | film | film | film | film | film | |
| | | R2 | AR | AR | AR | AR | AR | AR | AR | |
| | | | film + | film | film | film | film | film | film | |
| | | | cutoff | | | | | | | |
| | | | film | | | | | | | |
| Embodiment | Material | | Blue | Plastic | Plastic | Plastic | Plastic | Plastic | Plastic | None |
| Two | | | Glass | | | | | | | |
| | Surface | R1 | AR | AR | AR | AR | AR | AR | AR | |
| | | | film | film | film | film | film | film | film | |
| | | R2 | AR | AR | AR | AR | AR | AR | AR | |
| | | | film + | film | film | film | film | film | film | |
| | | | cutoff | | | | | | | |
| | | | film + | | | | | | | |
| | | | Absorbing | | | | | | | |
| | | | Coating | | | | | | | |

The structures of the corresponding lens modules in Table 1 for Comparative Embodiment One and Comparative Embodiment Two may be referred to as those in FIGS. 1 and 11, respectively, and the structures of the corresponding lens modules in Embodiment One and Embodiment Two may be referred to in FIGS. 2 and 5, respectively. The surfaces R1 and R2 in Table 1 correspond to the objective surface and the image surface of the lens, respectively.

The lens module provided in Comparative Embodiment Two also does not include a light filter. The ultraviolet infrared cutoff film is also used in Comparative Embodiment Two to replace the light filter in Embodiment One to make the lens module thinner and lighter, however, there is still an angular drift problem and a strong ghost phenomenon in Comparative Embodiment Two, which will be analyzed in conjunction with the accompanying drawings below.

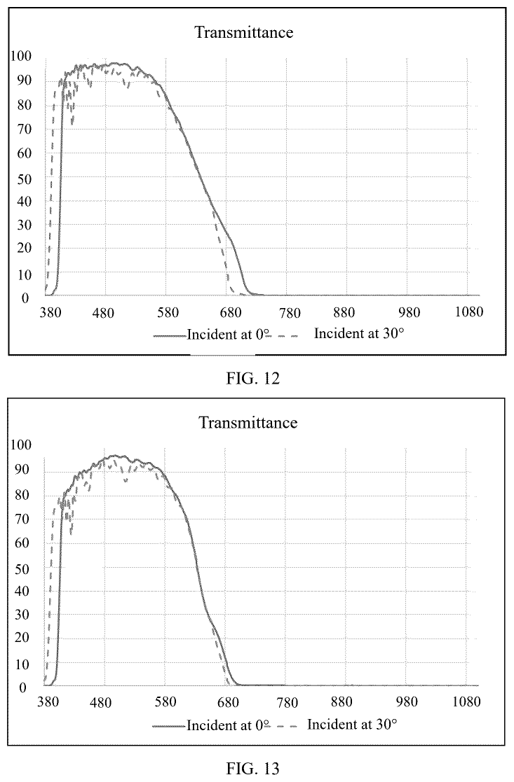

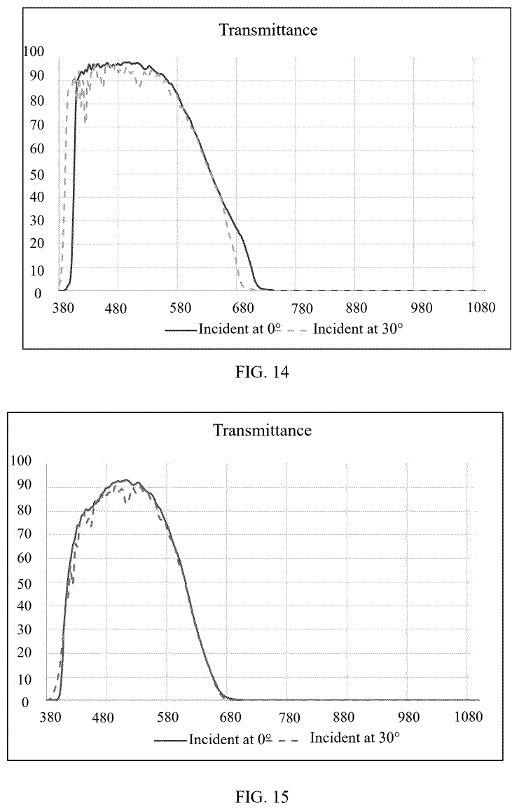

FIG. 12 shows a transmittance curve graph of light incident at 0° and 30° for the lens module in Comparative Embodiment One; FIG. 13 shows a transmittance curve graph of light incident at 0° and 30° for the lens module in Comparative Embodiment Two; FIG. 14 shows a transmittance curve graph of light incident at 0° and 30° for the lens module in Embodiment One; and FIG. 15 shows a transmittance curve graph of light incident at 0° and 30° for the lens module in Embodiment Two. The solid line indicates the 0° incident angle and the dashed line indicates the 30° incident angle.

As shown in FIGS. 12 to 15, the angular drift problem exists at 0° incidence angle and 30° incidence angle in the lens module of Comparative Embodiment One, Comparative Embodiment Two, and Embodiment One. The angular offset of Embodiment One is slightly lower than that of Comparative Embodiment One. The angular offset of Embodiment Two is smaller, which is significantly smaller than that of Comparative Embodiment One, Comparative Embodiment Two, and Comparative Embodiment Three. Thus, the lens module of the present application can improve the angular offset problem existing in the lens module in the related art.

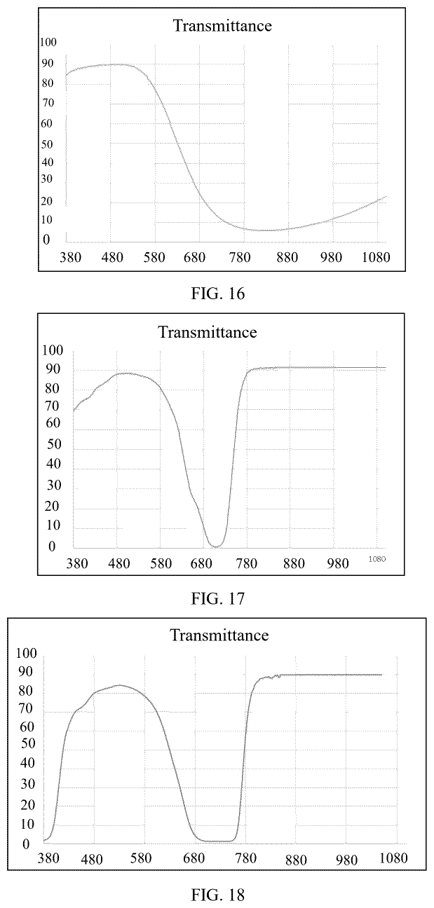

FIG. 16 shows a transmittance curve graph of light irradiated on the inside of the blue glass lens in Comparative Embodiment One, Embodiment One and Embodiment Two.

As shown in FIG. 16, the blue glass lenses in Comparative Embodiment One, Embodiment One and Embodiment Two have significant absorption at 550 nm-1100 nm, with strong absorption at about 830 nm. It can be understood that the blue glass lens in Comparative Embodiment One is the light filter in Comparative Embodiment One, the blue glass lens in Embodiment One is the first lens, and the blue glass lens in Embodiment Two is the first lens. The blue glass lens in Comparative Embodiment One, Embodiment One, and Embodiment Two all absorb light with the infrared band, which illustrates that the first lens in Embodiment One and Embodiment Two can replace the light filter in Comparative Embodiment One, making the lens module of Embodiment One and the lens module of Embodiment Two thinner and lighter.

FIG. 17 shows a transmittance curve graph of light irradiated on the inside of the stained plastic lenses in Comparative Embodiment Two.

As shown in FIG. 17, the stained plastic lens in Embodiment Two has obvious absorption at 380 nm-480 nm and 600 nm-800 nm, with strong absorption at about 710 nm. The stained plastic lens in Comparative Embodiment Two has a strong absorption of light in the infrared band, which allows the lens module of Comparative Embodiment Two to have a high infrared cutoff absorption value.

FIG. 18 shows a transmittance curve graph of light irradiated on the blue glass lens in Embodiment Two.

As shown in FIG. 18, the absorbing coating in Embodiment Two has obvious absorption at 380 nm-480 nm and 580 nm-800 nm, with strong absorption at about 380 nm and 700 nm-750 nm. The absorbing coating has a strong absorption of light in the infrared band, which can improve the infrared cutoff absorption value of the lens module in Embodiment Two.

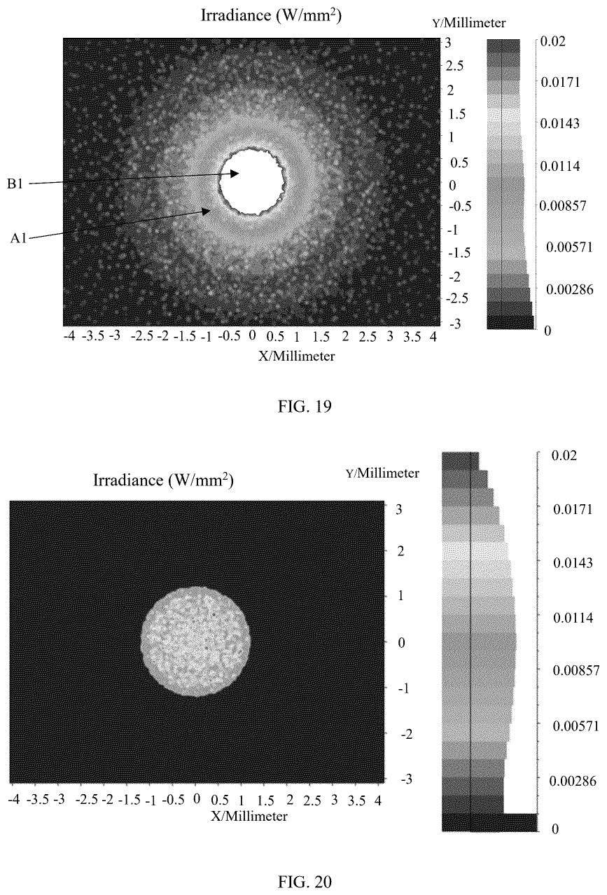

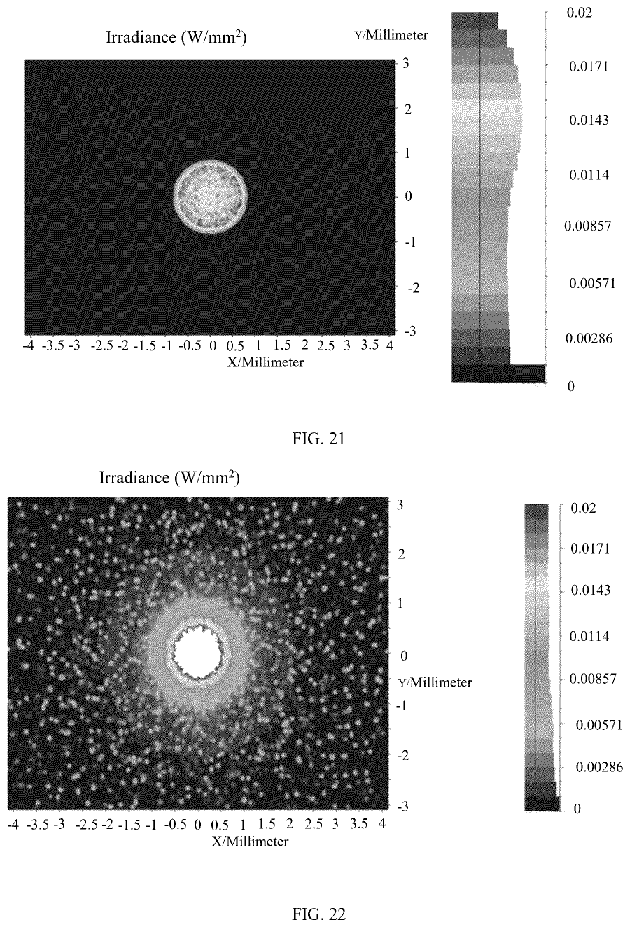

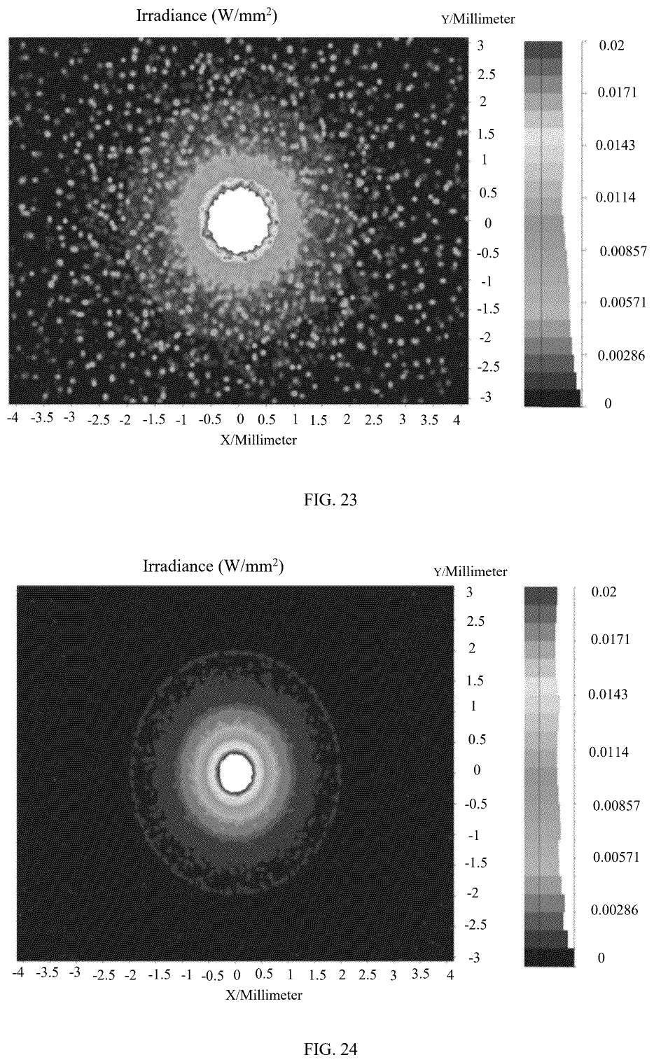

FIG. 19 shows a schematic diagram of a kind of ghosting simulation of the lens module in Comparative Embodiment One, and FIG. 20 shows an enlarged schematic diagram of the A1 region in FIG. 19. The optical path is formed as follows: the light incident at 0° from the objective surface passes through all of the lenses and then reflects on the objective surface of the light filter, and then passes in turn through the seventh lens, the sixth lens, and the fifth lens, and then and then reflects on the objective surface of the fifth lens, and then passes in turn through the sixth lens, the seventh lens and the light filter lens before reaching the imaging surface. FIG. 21 shows an enlarged schematic diagram of the B1 region in FIG. 19. The optical path is formed as follows: the light incident at 0° from the objective surface passes through all the lenses and is reflected at the objective surface of the light filter, and then passes through the seventh lens and is reflected on the image surface of the sixth lens, and then passes in turn through the seventh lens and the light filter and reaches the imaging surface. FIG. 22 shows a schematic diagram of a kind of ghosting simulation of the lens module in Comparative Embodiment Two; FIG. 23 shows a schematic diagram of a kind of ghosting simulation of the lens module in Embodiment One, and FIG. 24 shows a schematic diagram of a kind of ghosting simulation of the lens module in Embodiment Two.

As shown in FIGS. 19 to 24, the same optically designed lenses are used in Comparative Embodiment One, Comparative Embodiment Two, Embodiment One, and Embodiment Two, and the graphs in FIGS. 19 to 24 can be obtained by the ghost simulation using the Lighttools surface. It can be seen from the figures that, compared to the ghost phenomenon of the lens module in Comparative Embodiment One, the ghost phenomenon of the lens module in Comparative Embodiment Two, Embodiment One, and Embodiment Two are obviously weakened by removing the light filter, and the imaging quality of the lens module of Comparative Embodiment Two, Embodiment Two and Embodiment One is superior to the imaging quality of the lens module of Comparative Embodiment One. The ghosting phenomenon of the lens module of Embodiment Two is the weakest, and the imaging quality of the lens module of Embodiment Two is the best.

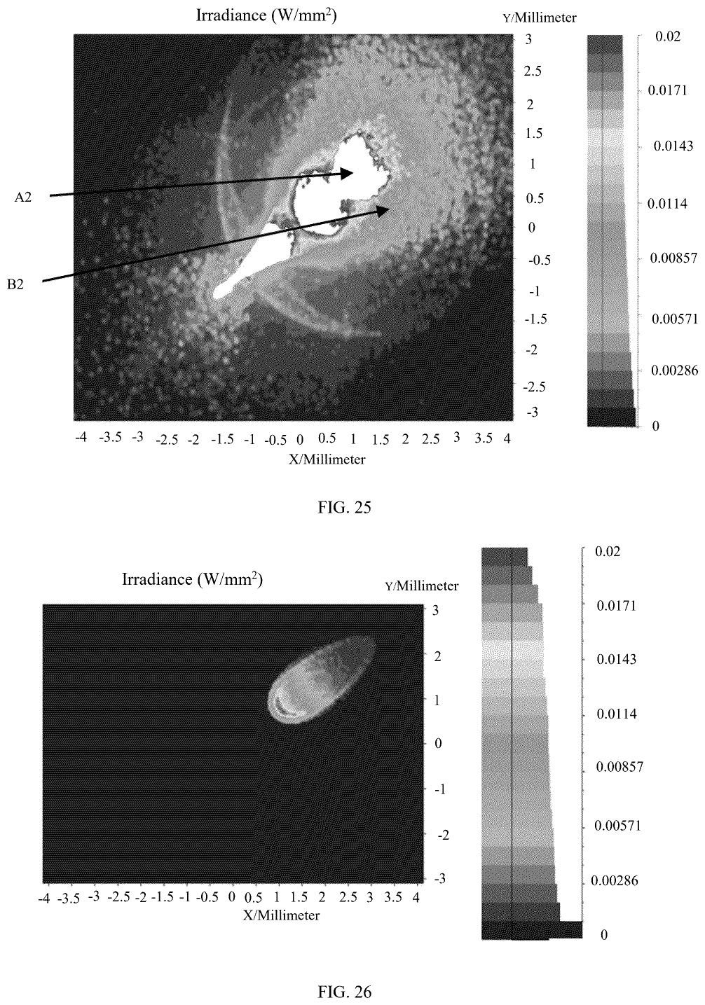

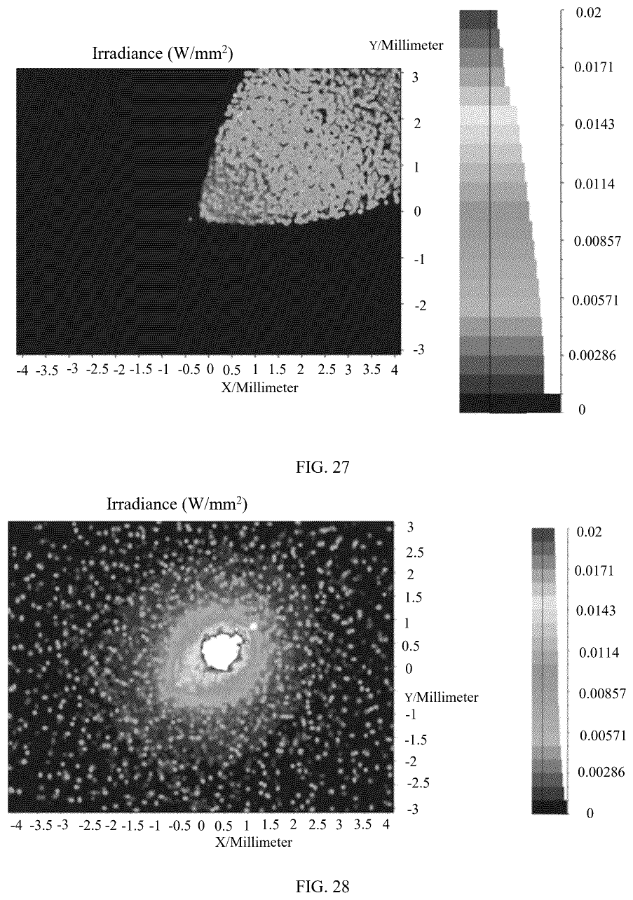

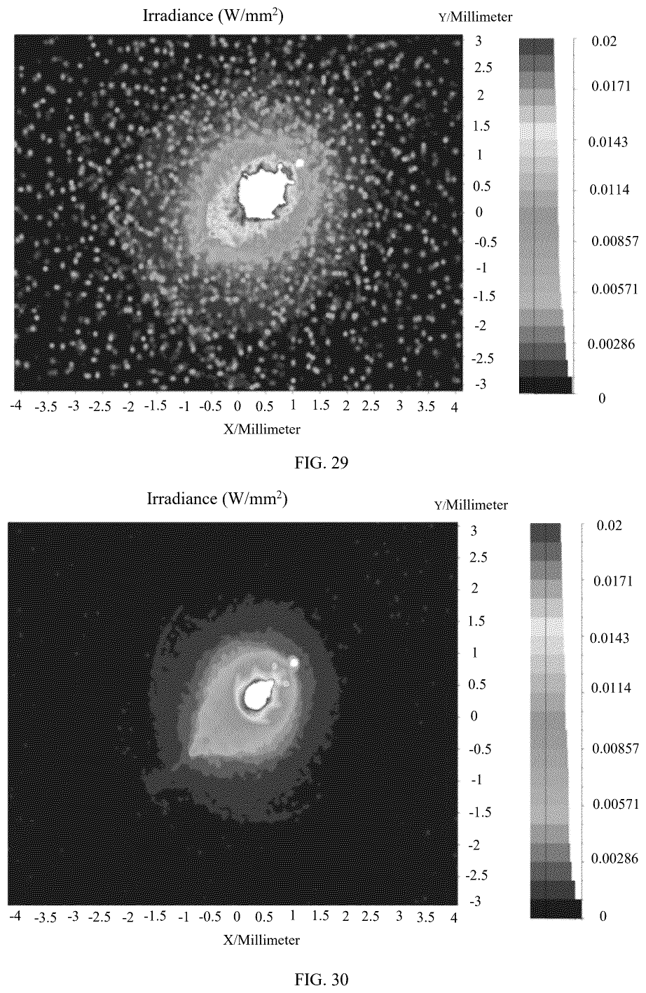

FIG. 25 shows a schematic diagram of a kind of ghosting simulation of the lens module in Comparative Embodiment One, and FIG. 26 is an enlarged schematic illustration of the A2 region in FIG. 25. The optical path is formed as follows: light incident at 5° from the objective surface passes through all the lenses and then reflects on the objective surface of the light filter, then passes through the seventh lens and reflects on the objective surface of the seventh lens, then passes through the seventh lens, the light filter in turn and then reaches the imaging surface. FIG. 27 is an enlarged schematic diagram of the B2 region in FIG. 25. The optical path is formed as follows: the light incident at 5° from the objective surface passes through all the lenses and then reflects on the objective surface of the light filter, then passes through the seventh lens and the sixth lens in turn, and reflects on the image surface of the fifth lens, then passes through the sixth lens, the seventh lens, and the light filter in turn and then reaches the imaging surface. FIG. 28 shows a schematic diagram of a kind of ghosting simulation of the lens module in Comparative Embodiment Two, FIG. 29 shows a schematic diagram of a kind of ghosting simulation of the lens module in Embodiment One, and FIG. 30 shows a schematic diagram of a kind of ghosting simulation of the lens module in Embodiment Two.

As shown in FIGS. 25 to 30, compared to the ghosting phenomenon of the lens module of Comparative Embodiment One, the ghosting phenomenon of the lens module of Comparative Embodiment Two, the lens module of Embodiment One, and the lens module of Embodiment Two are significantly weakened by canceling the light filter, and the imaging qualities of the lens module of the Comparative Embodiment Two, the lens module of the Embodiment One and the lens module of the Embodiment Two are better than the imaging quality of the lens module of the Comparative Embodiment One. The ghosting phenomenon of the lens module of Embodiment Two is the weakest, and the imaging quality of the lens module of Embodiment Two is the best.

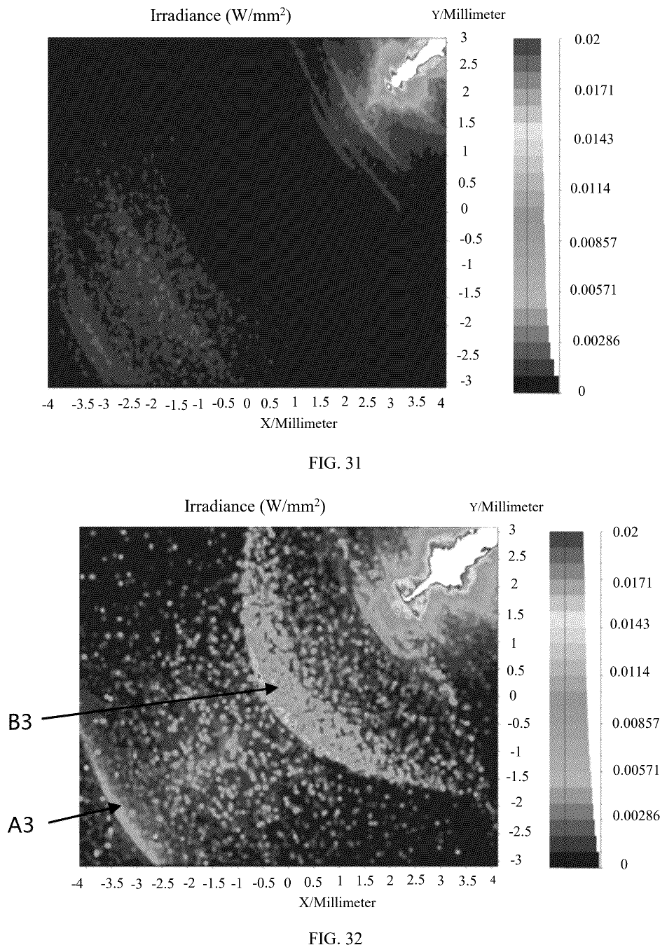

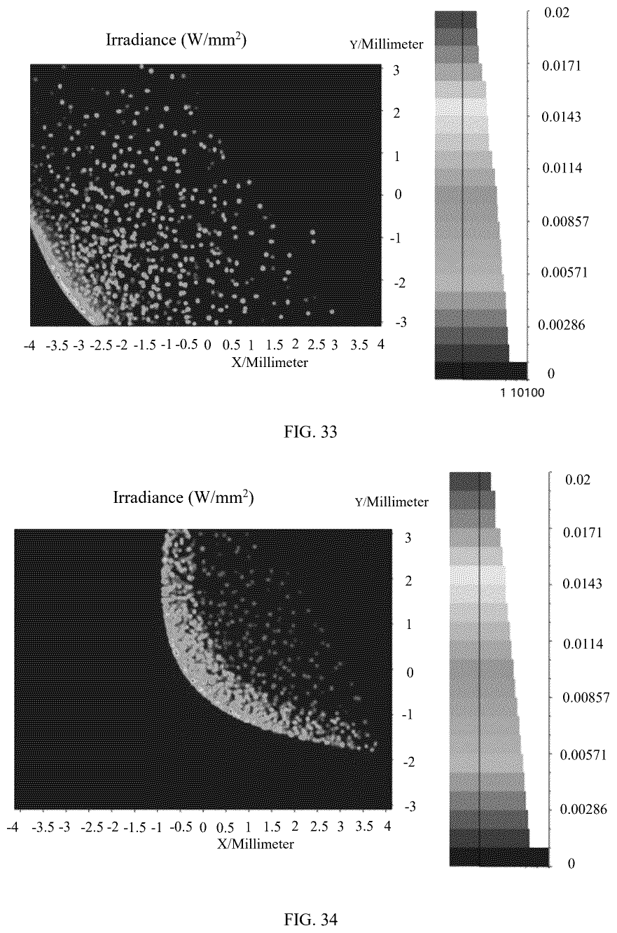

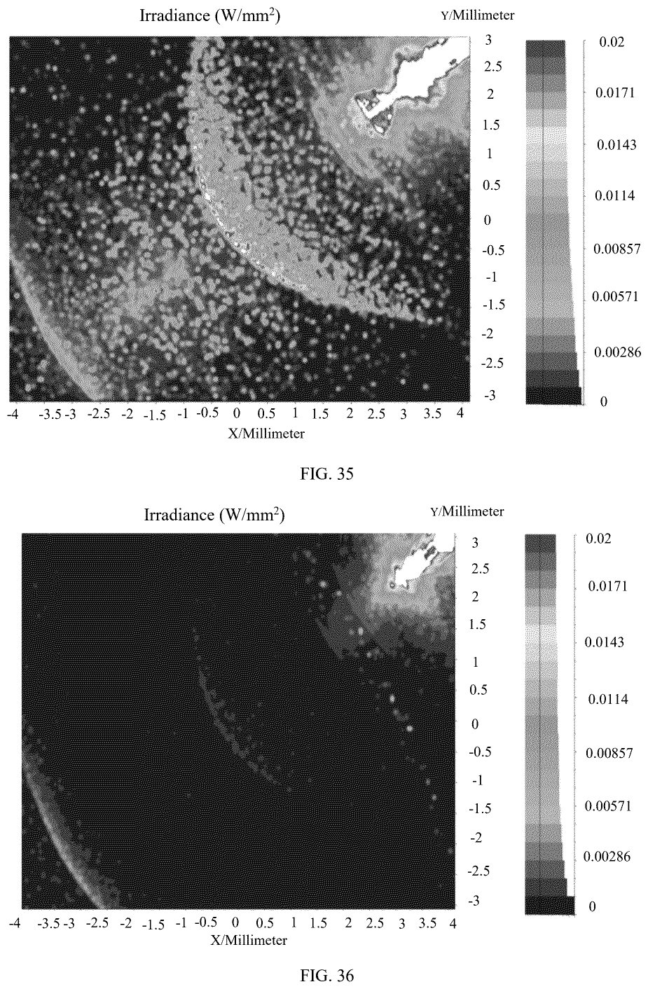

FIG. 31 shows a schematic diagram of a kind of ghosting simulation of the lens module in Comparative Embodiment One, and FIG. 32 shows a schematic diagram of a kind of ghosting simulation of the lens module in Comparative Embodiment Two; and FIG. 33 shows an enlarged schematic diagram of the A3 region in FIG. 32. The optical path is formed as follows: the light incident at 35° from the objective surface passes through the first lens, the second lens, the third lens, the fourth lens, and the fifth lens and then reflects in the objective surface of the sixth lens, and then passes through the fifth lens, the fourth lens, the third lens, the second lens and reflects on the image side of the first lens, and then passes through the second lens, the third lens, the fourth lens, and the fifth lens, the sixth lens, the seventh lens, and the filter in turn, and then reaches the imaging surface. FIG. 34 is an enlarged schematic diagram of the B3 region in FIG. 32, and the optical path is formed as follows: the light incident at 35° from the objective surface passes through the first lens, the second lens, the third lens, the fourth lens, and the fifth lens, and then reflects on the image surface of the fifth lens, and then passes through the fifth lens, the fourth lens, the third lens, and the second lens, and then reflects on the image surface of the first lens, and then passes through the second lens, the third lens, the fourth lens, and the fifth lens, the sixth lens, and the light filter in turn, and then reaches the imaging surface. FIG. 35 is a schematic diagram of a kind of ghosting simulation of the lens module in Embodiment One; FIG. 36 shows a schematic diagram of a ghosting simulation of the lens module in Embodiment Two.

As shown in FIGS. 31 to 36, compared to Comparative Embodiment One, the ghosting phenomenon associated with the image surface of the first lens L1 is produced in Comparative Embodiment Two, Embodiment One, and Embodiment Two. The ghosting phenomenon of Embodiment Two is the weakest, and the imaging quality of the lens module of Embodiment Two is superior to the imaging qualities of Comparative Embodiment Two and the imaging quality of the lens module of Embodiment One.

It can be understood that in the lens module in actual use, the light contains a variety of different incidence angles of the incident light, even though the lens module of Embodiment One has increased a portion of the ghosting associated with the side of the L1 image of the first lens at an incidence angle of 35°, the lens module of Embodiment One has a weaker ghosting phenomenon in the lens module at incidence angles of the light of other values, and weaker ghosting phenomenon than that of the lens module of Comparative Embodiment One and of Comparative Embodiment Two, so it can be considered that the lens module of Embodiment One and Embodiment Two of the present application can attenuate the ghosting phenomenon and improve the imaging quality of the lens module.

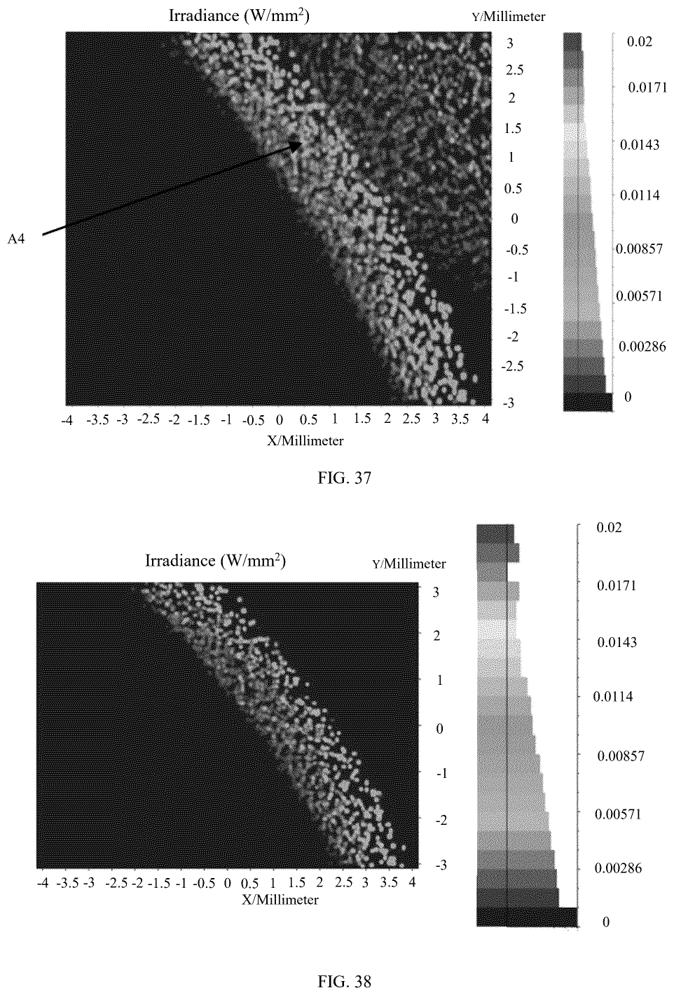

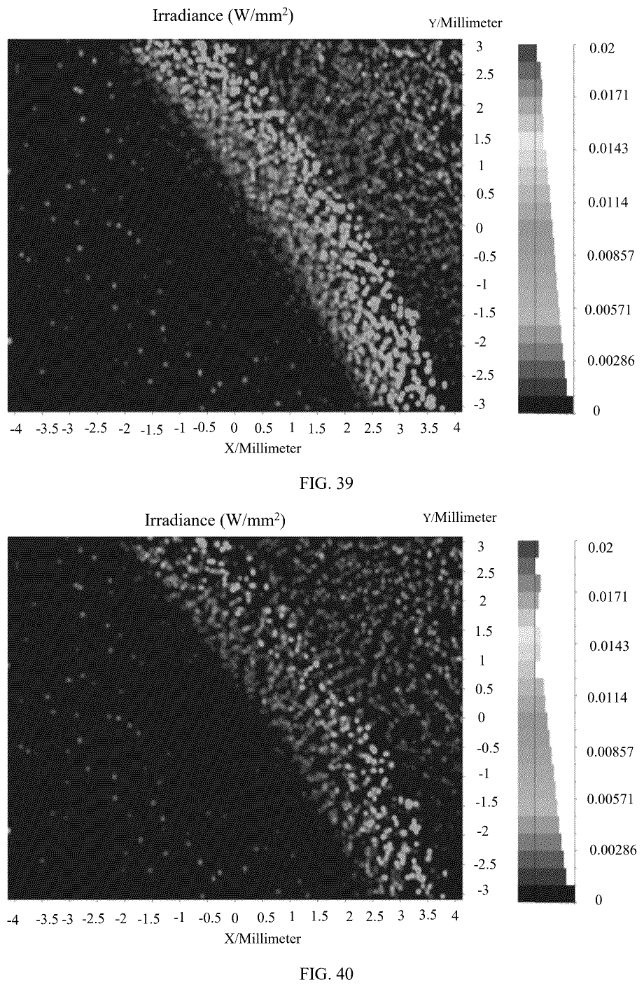

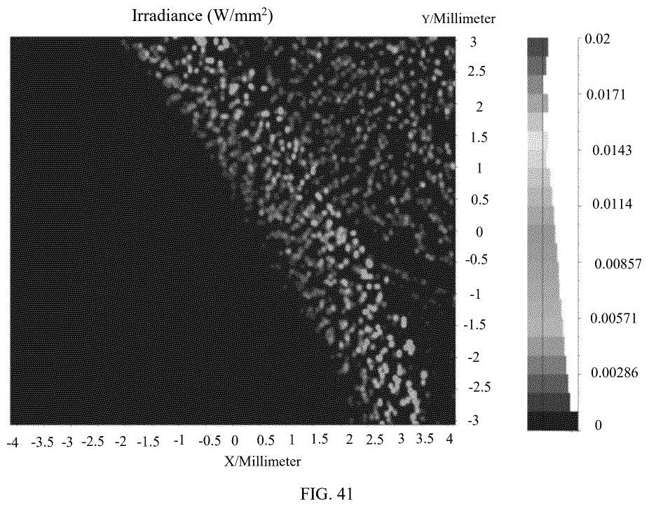

FIG. 37 shows a schematic diagram of a kind of ghosting simulation of the lens module in Comparative Embodiment One, and FIG. 38 is an enlarged schematic diagram of the A4 region in FIG. 37. The optical path is formed as follows: the light incident at 58° from the objective surface passes through the first lens and then reflects four times between the objective surface and the image surface of the first lens, and then passes through the second lens, the third lens, the fourth lens, and the fifth lens, the sixth lens, the seventh lens, and the light filter, and then reaches the image surface. FIG. 39 is a schematic diagram of a kind of ghosting simulation of the lens module in Comparative Embodiment Two; FIG. 40 is a schematic diagram of a kind of ghosting simulation of the lens module in Embodiment One; and FIG. 41 shows a schematic diagram of a kind of ghosting simulation of the lens module in Embodiment Two.

As shown in FIGS. 37 to 41, compared to the lens module in Comparative Embodiment One, the ghosting phenomenon in Embodiment Two and Embodiment One, is significantly weakened after canceling the light filter in the lens module. The ghosting phenomenon in Comparative Embodiment Two is stronger than that in Comparative Embodiment One, and the imaging qualities of the lens module of Embodiment Two and the lens module of Embodiment One are higher.

By comparing the ghosting simulation schematic diagrams of the lens module of Comparative Embodiment One, Comparative Embodiment Two, Embodiment One, and Embodiment Two at different angles, it can be found that the ghosting phenomenon of Embodiment One and Embodiment Two of the present application is weaker than that of Comparative Embodiment One, Comparative Embodiment Two, and Embodiment One. Embodiment One and Embodiment Two of the present application can attenuate the ghosting phenomenon of the lens module in the related art, so that Embodiment One and Embodiment Two of the present application can improve the optical quality of the lens module. The ghosting phenomenon of Embodiment Two is weaker than the ghosting phenomenon of Embodiment One, and the optical quality of the lens module of Embodiment Two is the best.

Table 2 shows the test results of the reliability tests of Comparative Embodiment One, Comparative Embodiment Two, Embodiment One, and Embodiment Two.

In Table 2, the specific test environments are, respectively, high temperature and high humidity: 85° C.±2° C., 85%+5% RH, 480 h; high temperature: 85° C.±2° C., 600 h; low temperature: −40° C.±2° C., 600 h; cold and thermal shock: 120 cycles; 1 cycle: −40° C. (30 minutes), 85° C. (30 minutes), 600 h.

TABLE 2

| | Environment | | | |
|---|---|---|---|---|
| | High | | | |
| | Temperature | | | Cold and |
| | and High | High | Low | Thermal |
| | Humidity | Temperature | Temperature | Shock |
| Sample | 600 h | 600 h | 600 h | 600 h |
| Comparative | In Good | In Good | In Good | In Good |
| Embodiment | Condition | Condition | Condition | Condition |
| One | | | | |
| Comparative | In Good | In Good | In Good | In Good |
| Embodiment | Condition | Condition | Condition | Condition |
| Two | | | | |
| Embodiment | In Good | In Good | In Good | In Good |
| One | Condition | Condition | Condition | Condition |
| Embodiment | In Good | In Good | In Good | In Good |
| Two | Condition | Condition | Condition | Condition |

As shown in Table 2, in the reliability test, under different test environments, the lens modules of Comparative Embodiment One, Comparative Embodiment Two, Embodiment One, and Embodiment Two are in good condition in appearance, with no problems of fogging of the film layer, delamination of the film, cracking of the film, or bulging of the film. This also shows that, in the lens module of the embodiment of the present application, after depositing a cutoff film on the glass lens and spin-coating an absorbing coating on either lens to replace the light filter in the related art, the lens module of the embodiment of the present application still has excellent reliability under different test environments.

In the above embodiment of the invention of the lens module, the presence of the specific wavelength-absorbing glass lens and the ultraviolet infrared cutoff film can replace the light filter in the related art, so that the thickness of the lens module of the embodiment of the present application is smaller. When at least one of the plurality of lenses of the lens module is a specific wavelength-absorbing glass lens, the ultraviolet infrared cutoff film is arranged on a smooth surface of the specific wavelength-absorbing glass lens. The smooth surface is smoother, so that the spectral drift between the center and edge positions of the lens can be smaller. Besides, the specific wavelength-absorbing glass lens enables the lens module of the embodiment of the present application to improve the problem of angular drift with respect to the angle of incidence, and the lens module of the embodiment of the present application can also attenuate the ghosting phenomenon, so that the imaging quality of the lens module can be improved. When the plurality of lens lenses of the lens module includes at least one specific wavelength-absorbing glass lens and at least one second glass lens, the ultraviolet infrared cutoff film is arranged on the smooth surface of the specific wavelength-absorbing glass lens or on the smooth surface of the second glass lens. The smooth surface is smooth, so that the spectral drift of the center and edge positions of the lens can be smaller, and the lens module of the embodiments of the present application can improve the angular drift problem. Besides, the lens module of the embodiments of the present application can also attenuate the ghosting phenomenon and improve the imaging quality of the lens module.

Another embodiment of the present application provides a terminal device including the lens module described in the above-mentioned embodiments, and the same or corresponding portions as the previous embodiment can be referred to the corresponding descriptions of the previous embodiment, which will not be described in detail below. The terminal device may be a smartphone, a tablet computer, a laptop computer, or a smartwatch, etc.

Any person of ordinary skill in the art may understand that each of the above-mentioned embodiments is a specific embodiment for realizing the present application, and that various changes may be made thereto in form and detail in practical application without deviating from the spirit and scope of the present application. Any person skilled in the art may make various changes and modifications without departing from the spirit and scope of the present application, and therefore the protection scope of the present application shall be subject to the scope limited by the claims.

What is claimed is:

1. A lens module, comprising:
a plurality of lenses arranged in sequence from an objective side to an image side, wherein any one of the plurality of lenses has an image surface facing the image side and an objective surface facing the objective side; there is at least one smooth surface among the objective surfaces and the image surfaces, and an angle between a tangent line of a point within an optically effective diameter on the smooth surface used for imaging other than a center of the smooth surface and a tangent line of the center of the smooth surface is 0°-20°; at least one of the plurality of lenses is a specific wavelength-absorbing glass lens and at least one of the smooth surfaces is located on the specific wavelength-absorbing glass lens; and
an ultraviolet infrared cutoff film, wherein the ultraviolet infrared cutoff film is arranged on the smooth surface of the specific wavelength-absorbing glass lens, and the ultraviolet infrared cutoff film is absorptive of light with ultraviolet and infrared bands.

2. The lens module of claim 1, further comprising an absorbing coating, wherein the absorbing coating is configured to absorb light with a specific wavelength, and the specific wavelength comprises at least one of an ultraviolet band, an infrared band, and a near-infrared band; the absorbing coating and the ultraviolet infrared cutoff film are both arranged on the smooth surface of the specific wavelength-absorbing glass lens, and the absorbing coating is located between the ultraviolet infrared cutoff film and the smooth surface.

3. The lens module of claim 1, further comprising:
an absorbing coating, wherein the absorbing coating is configured to absorb light with a specific wavelength, and the specific wavelength comprises at least one of an ultraviolet band, an infrared band, and a near-infrared band; and
a plastic lens, wherein the other smooth surface is arranged on the plastic lens; the ultraviolet infrared cutoff film is arranged on the smooth surface of the specific wavelength-absorbing glass lens, and the absorbing coating is provided on the smooth surface of the plastic lens.

4. The lens module of claim 1, wherein the specific wavelength-absorbing glass lens is a blue glass lens or a stained glass for absorbing light with an infrared band.

5. A lens module, comprising:
a plurality of lenses arranged in sequence from an objective side to an image side, wherein any one of the plurality of lenses has an image surface facing the image side and an objective surface facing the objective side; there is at least one smooth surface among the objective surfaces and the image surfaces, and an angle between a tangent line of a point within an optically effective diameter on the smooth surface used for imaging other than a center of the smooth surface and a tangent line of the center of the smooth surface is 0°-20°; the plurality of lenses comprise at least one specific wavelength-absorbing glass lens and at least one second glass lens; and
an ultraviolet infrared cutoff film, wherein the ultraviolet infrared cutoff film is provided on the smooth surface of the specific wavelength-absorbing glass lens or on the smooth surface of the second glass lens, and the ultraviolet infrared cutoff film is absorptive of light in the ultraviolet and infrared bands.

6. The lens module of claim 5, further comprising an absorbing coating, wherein the absorbing coating is configured to absorb light with a specific wavelength, and the specific wavelength comprises at least one of an ultraviolet band, an infrared band, and a near-infrared band; the absorbing coating and the ultraviolet infrared cutoff film are both arranged on the same smooth surface, and the absorbing coating is located between the ultraviolet infrared cutoff film and the smooth surface.

7. The lens module of claim 5, further comprising an absorbing coating, wherein the absorbing coating is configured to absorb light with a specific wavelength, and the specific wavelength comprises at least one of an ultraviolet band, an infrared band, and a near-infrared band; one of the ultraviolet infrared cutoff film and the absorbing coating is arranged in the smooth surface of the specific wavelength-absorbing glass lens, and the other one of the ultraviolet infrared cutoff film and the absorbing coating absorbing coating is arranged in the second glass lens of the smooth surface.

8. The lens module of claim 5, further comprising:
absorbing coatings, wherein each of the absorbing coatings is configured to absorb light with a specific wavelength, and the specific wavelength comprises at least one of an ultraviolet band, an infrared band, and a near-infrared band; and
a plastic lens, wherein one of the absorbing coatings is arranged on a smooth surface of the plastic lens.

9. The lens module of claim 5, wherein the specific wavelength-absorbing glass lens is a blue glass lens or a stained glass for absorbing light with an infrared band.

10. A terminal device, comprising a lens module of claim 1.
